(19) United States
(12) Patent Application Publication
(10) Pub. No.: US 2019/0278267 A1
(43) Pub. Date: Sep. 12, 2019

(54) VEHICLE CONTROL DEVICE

(71) Applicant: HONDA MOTOR CO., LTD., Tokyo (JP)

(72) Inventor: Shigehiro HONDA, Wako-shi (JP)

(21) Appl. No.: 16/281,874

(22) Filed: Feb. 21, 2019

(30) Foreign Application Priority Data
Mar. 7, 2018 (JP) 2018-040963

(51) Int. Cl. G05D 1/00; B60W 40/09; G06K 9/00

(52) U.S. Cl. CPC G05D 1/0061; B60W 40/09; B60W 2050/007; G05D 1/0088; G06K 9/00845

(57) ABSTRACT

According to the present invention, a vehicle control device is provided. The vehicle control device comprises a surroundings monitor provided in a vehicle to monitor a surrounding state of the vehicle, and a vehicle controller that performs control of the vehicle based on the surrounding state monitored by the surroundings monitor. A control state by the vehicle controller includes a first state and a second state in which an automation level of the control is higher than in the first state. Operation methods of respective operations for finishing the first state and the second state by operation of a driver or determination methods of the operations are different in the first state and the second state.

### CROSS-REFERENCE TO RELATED APPLICATION(S)

This application claims priority to and the benefit of Japanese Patent Application No. 2018-040963 filed on Mar. 7, 2018, the entire disclosure of which is incorporated herein by reference.

### BACKGROUND OF THE INVENTION

### Field of the Invention

The present invention relates to a vehicle control device for performing automated driving and driving support of an automobile, for example.

### Description of the Related Art

In automated driving or driving support of vehicles including a four-wheel vehicle, a specific direction or all directions of the vehicle are monitored by sensors, the state of a driver and the traveling state of the vehicle are monitored, and in response to the monitoring results, automated driving of the vehicle on an appropriate route at an appropriate speed is controlled, or driving by the driver is supported. Even in a vehicle having the automated driving function like this, there is a demand for a driver to be involved mainly in driving, and such a situation and a state may occur. In preparation for the case like this, there may be provided an operation switch for finishing the present automated driving level, and causing the automated driving level to transition to a new level.

Operation switches may be operated erroneously, and when the automated driving level is lowered by an erroneous operation in the case of finishing the automated driving level with a high automation rate in particular, it may be difficult for the driver to follow a new automated driving level immediately. Thus, there are proposed arts of allowing switching from automated driving to manual driving when there is a clearance from surrounding targets (refer to Japanese Patent Laid-Open No. 2011-131838), changing a transition period of the driving depending on an environment (refer to Japanese Patent Laid-Open No. 10-309961), canceling a cancelation operation of automated driving when erroneous operation determination is performed and the determination result is an erroneous operation (refer to Japanese Patent Laid-Open No. 2012-111263), and the like.

However, when automated driving at a high level is cancelled by an erroneous operation, it may be difficult for the driver to follow automated driving of a low level or manual driving quickly, as described above, and it is necessary to strengthen prevention of an erroneous operation particularly during automated driving at a high level.

### SUMMARY OF THE INVENTION

The present invention has an object to provide a vehicle control device that, according to a level of automated driving, prevents end of the automated driving at the level by an erroneous operation.

The present invention has the following configuration.

That is, according to one aspect of the present invention, the present invention includes a surroundings monitor provided in a vehicle to monitor a surrounding state of the vehicle, and a vehicle controller that performs control of the vehicle based on the surrounding state monitored by the surroundings monitor, wherein a control state by the vehicle controller includes a first state and a second state in which an automation level of the control is higher than in the first state, and operation methods of respective operations for finishing the first state and the second state by operations of a driver or determination methods of the operations are different in the first state and the second state.

According to the present invention, according to a level of automated driving, end of the automated driving at the level by an erroneous operation can be prevented.

Further features of the present invention will become apparent from the following description of exemplary embodiments with reference to the attached drawings.

### BRIEF DESCRIPTION OF THE DRAWINGS

FIG. 1 is a diagram illustrating a configuration of a vehicle system of an automated driving vehicle of an embodiment;

FIG. 2 is a state transition diagram illustrating transition of an automated driving level according to a first embodiment;

FIG. 3 is a flowchart of processing at a time of depressing a cancel switch of automated driving according to the first embodiment;

FIG. 4A is a flowchart of processing at the time of depressing the cancel switch of the automated driving according to the first embodiment;

FIG. 4B is a flowchart of first predetermined time setting processing according to a first modified example common to the first embodiment and a second embodiment;

FIG. 5 is a state transition diagram illustrating transition of an automated driving level according to the second embodiment;

FIG. 6 is a flowchart of processing at the time of depressing the cancel switch of automated driving according to the second embodiment;

FIG. 7A is a flowchart illustrating processing at the time of depressing the cancel switch of the automated driving according to the second embodiment; and

FIG. 7B is a flowchart illustrating determination processing of automated driving cancellation in a second modified example of the first embodiment.

### DESCRIPTION OF THE EMBODIMENTS

### First Embodiment

Outline of Automated Driving and Travelling Support

Next, an outline of an example of automated driving will be described. In automated driving, a driver sets a destination from a navigation system mounted on a vehicle and determines a route to the destination by a server or the navigation system, before traveling. When the vehicle is started, a vehicle control device (or a driving control device) configured by an ECU and the like of the vehicle drives the vehicle to the destination along the route. During that time, the vehicle control device determines an appropriate action at an appropriate time in response to elements in the external environment such as a route and a road situation, a state of the driver and the like, and causes the vehicle to travel by performing, for example, driving control, steering control, braking control and the like for the action. These kinds of control may be collectively called traveling control.

There are several levels (automation levels or simply called states) in automated driving depending on the automation rate (or an amount of task required of the driver). In general, as the automation level is higher, the task (that is, a load) required of the driver is reduced more. For example, in the level in the highest order (a third level) in the present example, the driver may pay attention to things other than driving. This is performed in an environment which is not so complicated such as the case of following the car in front in the traffic jam on a highway, for example. Further, in a second level of a lower order from the third level, the driver does not have to hold the steering wheel, but needs to pay attention to a surrounding situation and the like. The second level may be applied to a case of cruising on a highway or the like with few obstacles. It can be detected by a driver state detecting camera 41a that the driver pays attention to surroundings, and it can be detected by a steering wheel grasping sensor not illustrated that the driver grasps the steering wheel. With the driver state detecting camera 41a, a watching direction may be determined by recognizing pupils of the driver, and in a simpler way, a face is recognized, and a direction in which the face is directed may be estimated as the watching direction of the driver.

In a first level at a lower order from the second level, the driver does not have to perform a steering wheel operation or a throttle operation, but needs to hold the steering wheel to prepare for transfer (takeover) of driving control from the vehicle to the driver, and pay attention to driving. A 0^{th} level at a further lower order from the first level is manual driving, but includes automated driving support. A difference between the first level and the 0^{th} level is that the first level is one of the levels of automated driving and can transition to the second and third levels under control by the vehicle 1 in response to the external environment, the traveling state, the driver state and the like, whereas in the 0^{th} level, the level remains in the 0^{th} level as long as there is no switching instruction to the automated driving by the driver.

The driving support in the aforementioned 0^{th} level is a function of supporting the driving operation by the driver who mainly drives by monitoring surroundings and partial automation. For example, the driving support includes LKAS (Lane Keeping Assist System) and ACC (Adaptive Cruise Control). Further, there are an automated braking function of braking when monitoring only a front and detecting an obstacle, a rear monitoring function of detecting vehicles at an obliquely rear side and urging the driver to pay attention, a function of parking in a parking space and the like. All of the functions may be realized also in the first level of automated driving. Note that LKAS is a function of keeping a lane by recognizing a white line or the like on a road, for example, and ACC is a function of tracking a vehicle traveling in front according to the speed of the vehicle.

Even during automated driving, the driver may intervene in the driving. This is called override. For example, when the driver performs a steering and an acceleration operation during automated driving, the driving operation by the driver may be prioritized. In this case, even when the driver stops the operations, the automated driving is continuously working so as to be able to restart automated driving from a time point of stopping the operation. Accordingly, even during override, the automated driving level can vary. Further, when the driver performs a braking operation, the automated driving may be cancelled to shift to the manual driving.

When the automated driving level (or the automation level) is switched, the driver is notified of switching by the vehicle by sound, display, vibration or the like. For example, when automated driving is switched to the second level from the first level mentioned above, the driver is notified that the driver may release the steering wheel. In the opposite case, the driver is notified to grasp the steering wheel. The notice is repeatedly issued until it is detected that the driver grasps the steering wheel by a steering wheel grasping sensor. When the steering wheel is not grasped within a time limit, for example, or by a critical point of mode switching, an operation of stopping the vehicle in a safe place or the like may be performed. Although switching from the second level to the third level is the same, in the third level, surrounding monitoring obligation of the driver is released, so that the driver is notified of a message of the surrounding monitoring obligation being released. In the opposite case, the driver is notified to monitor the surroundings. The notice is repeatedly issued until it is detected that the driver monitors surroundings by a driver state detecting camera 41a. Automated driving is performed substantially as described above, and a configuration and control for the automated driving will be described as follows.

Configuration of Vehicle Control Device

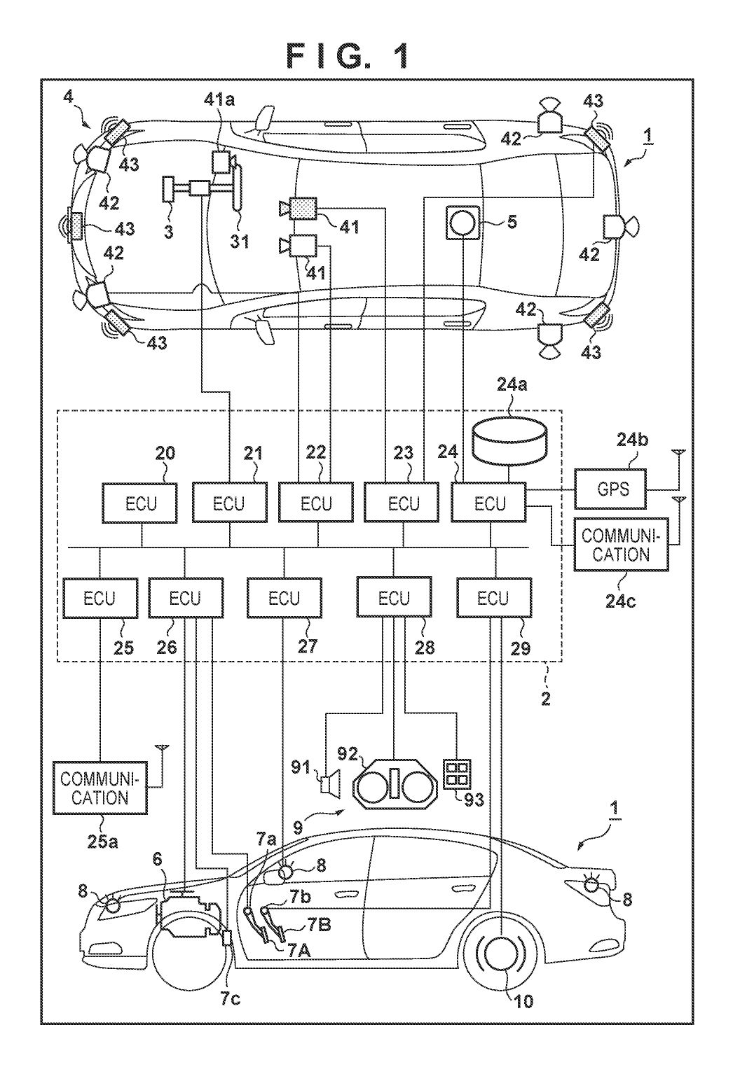

FIG. 1 is a block diagram of the vehicle control device according to one embodiment of the present invention, which controls a vehicle 1. In FIG. 1, an outline of the vehicle 1 is illustrated in a plan view and a side view. The vehicle 1 is a sedan type four-wheeled passenger car, as an example.

A control device in FIG. 1 includes a control unit 2. The control unit 2 includes a plurality of ECUs 20 to 29 that are communicably connected by an in-vehicle network. Each of the ECUs includes a processor represented by a CPU, a memory device such as a semiconductor memory, an interface with an external device and the like. In the memory device, a program executed by the processor, data that is used by the processor in processing and the like are stored. Each of the ECUs may include a plurality of processors, memory devices, interfaces and the like.

Hereinafter, functions and the like that are taken charge of by the respective ECUs 20 to 29 will be described. The number of ECUs, and functions taken charge of by the ECUs can be properly designed for the vehicle 1, and may be fractionized more, or integrated more than the present embodiment.

The ECU 20 executes control relating to automated driving of the vehicle 1. In the automated driving, at least either one of steering of the vehicle 1, and acceleration and deceleration is automatedly controlled. In a control example to be described later, both of steering, and acceleration and deceleration are automatedly controlled.

The ECU 21 controls an electric power steering device 3. The electric power steering device 3 includes a mechanism that steers front wheels in response to a driving operation (steering operation) of the driver to a steering wheel 31. Further, the electric power steering device 3 includes a motor that assists a steering operation or exhibits a driving force for automatically steering the front wheels, a sensor that detects a steering angle and the like. When the driving state of the vehicle 1 is automated driving, the ECU 21 automatedly controls the electric power steering device 3 in response to an instruction from the ECU 20, and controls a traveling direction of the vehicle 1.

The ECUs 22 and 23 perform control of detection units 41 to 43 that detect a surrounding situation of the vehicle and information processing of a detection result. The surrounding situation is also called a surrounding state and an external environment, and information obtained by detecting them is called surrounding situation information, surrounding state information, external environment information or the like. The detection units for the surrounding state, and the ECUs that perform control of the detection units are collectively called a surrounding monitoring device, a surrounding monitoring unit or the like. The detection unit 41 is a camera that photographs a front of the vehicle 1 (hereinafter, sometimes described as a camera 41), and in the case of the present embodiment, two of the detection units 41 are provided in an interior of the vehicle 1. By analysis of an image photographed by the camera 41, a contour of a target can be extracted, and carriageway marking (white line and the like) of a lane on a road can be extracted. A detection unit 41a is a camera for detecting a state of the driver (hereinafter, sometimes described as a driver state detecting camera 41a), is installed to capture an expression of the driver, and is connected to an ECU that performs processing of the image data though not illustrated. Further, there is a steering wheel grasping sensor not illustrated, as a sensor for detecting a diver state. Thereby, it can be detected whether or not the driver grasps the steering wheel. The driver state detecting camera 41a and the steering wheel grasping sensor are also collectively referred to as a driver state detecting unit.

The detection unit 42 is LIDAR (Light Detection and Ranging, or Laser Imaging Detection and Ranging) (hereinafter, sometimes described as the LIDAR 42), which detects a target around the vehicle 1, and measures a distance from the target. In the case of the present embodiment, five LIDARs 42 are provided, one for each corner portions of a front portion of the vehicle 1, one for a center of a rear portion, and one for each side of a rear portion. The detection unit 43 is a millimeter wave radar (hereinafter, sometimes described as the radar 43), which detects a target around the vehicle 1, and measures a distance from the target. In the case of the present embodiment, five radars 43 are provided, one for a center of the front portion of the vehicle 1, one for each corner portion of the front portion, and one for each corner portion of the rear portion.

The ECU 22 performs control of the one camera 41, the respective LIDARs 42 and information processing of the detection results. The ECU 23 performs control of the other camera 41 and the respective radars 43, and information processing of the detection results. Two sets of the devices detecting the surrounding situation of the vehicle are included, so that reliability of the detection results can be enhanced, and different kinds of detection units such as the camera, LIDAR and the radar are included, so that analysis of the surrounding environment (also referred to as the surrounding state) of the vehicle can be performed multilaterally.

An ECU 24 performs control of a gyro sensor 5, a GPS sensor 24b, and a communication device 24c and information processing of the detection results or communication results. The gyro sensor 5 detects rotational movement of the vehicle 1. A course of the vehicle 1 can be determined by a detection result of the gyro sensor 5, a wheel speed and the like. The GPS sensor 24b detects a present position of the vehicle 1. The communication device 24c performs wireless communication with a server that provides map information and traffic information, and acquires these kinds of information. The ECU 24 is accessible to the database 24a of the map information constructed in the memory device, and the ECU 24 performs route search to a destination from a present location, and the like.

An ECU 25 includes a communication device 25a for communication between vehicles. The communication device 25a performs wireless communication with other surrounding vehicles, and exchanges information with the vehicles.

An ECU 26 controls a power plant 6. The power plant 6 is a mechanism that outputs a driving force that rotates driving wheels of the vehicle 1, and includes, for example, an engine and a transmission. The ECU 26 controls output of the engine in response to a driving operation (an accelerator operation or accelerating operation) of the driver that is detected by an operation detecting sensor 7a provided at an accelerator pedal 7A, for example, and switches a gear ratio of the transmission based on the information on a vehicle speed or the like detected by a vehicle speed sensor 7c. When the driving state of the vehicle 1 is automated driving, the ECU 26 automatedly controls the power plant 6 in response to an instruction from the ECU 20, and controls acceleration and deceleration of the vehicle 1. Accelerations in respective directions and an angular acceleration around an angular axis that are detected by the gyro sensor 5, a vehicle speed detected by the vehicle speed sensor 7c and the like are information indicating a traveling state of the vehicle, and these sensors are also collectively referred to as a traveling state monitoring unit. Further, the operation detecting sensor 7a of the accelerator pedal 7A and an operation detecting sensor 7b of a brake pedal 7B that will be described later may be included in the traveling state monitoring unit, but in the present example, these sensors are referred to as an operating state detecting unit with detection units not illustrated that detect operating states to other devices.

An ECU 27 controls lighting devices (a headlight, a tail light and the like) including a direction indicator 8. In the case of the example in FIG. 1, the direction indicator 8 is provided at the front portion, door mirrors and the rear portion of the vehicle 1.

An ECU 28 performs control of an input/output device 9. The input/output device 9 outputs information to the driver and receives input of information from the driver. An audio output device 91 informs the driver of information by a sound. A display device 92 informs the driver of information by display of an image. The display device 92 is disposed on, for example, a driver's seat front surface and configures an instrument panel or the like. Here, sound and display are illustrated, but the driver may be informed of information by vibration or light. Further, the driver may be informed of information by combining a plurality of things of a sound, display, vibration and light. Further, the combination may be made different, or an informing mode may be made different according to a level (for example, a degree of urgency) of the information to be informed. An input device 93 is a switch group that is disposed in a position where the driver can operate the input device 93 to perform an instruction to the vehicle 1, and may include an audio input device. The input device 93 also includes a cancel switch for manually lowering the level of the automated driving. The driver who desires to lower the level of the automated driving can lower the level by operating the cancel switch. In the present embodiment, the level can be lowered by the same cancel switch, regardless of the level of the automated driving. However, separate switches may be provided for respective levels. Alternatively, with use of the same switch, operation methods may be made different for the respective levels. In the present embodiment, the cancel switch is formed into a button shape, and the driver performs a cancel operation by depressing the switch. Besides the above, other operation methods may be adopted, such as an operation of a lever (for example, pulling) provided at a side of a steering wheel, for example.

The ECU 29 controls the braking device 10 and a parking brake (not illustrated). The braking device 10 is, for example, a disk braking device, is provided at each of wheels of the vehicle 1, and decelerates or stops the vehicle 1 by applying resistance to rotation of the wheels. The ECU 29 controls an operation of the braking device 10 in response to a driving operation (braking operation) of the driver that is detected by the operation detecting sensor 7b provided at the brake pedal 7B, for example. When the driving state of the vehicle 1 is automated driving, the ECU 29 automatedly controls the braking device 10 in response to an instruction from the ECU 20, and controls deceleration and stoppage of the vehicle 1. The braking device 10 and the parking brake also can be operated to keep a stopping state of the vehicle 1. Further, when the transmission of the power plant 6 includes a parking lock mechanism, the parking lock mechanism also can be operated to keep the stopping state of the vehicle 1.

Transition of Automated Driving Level

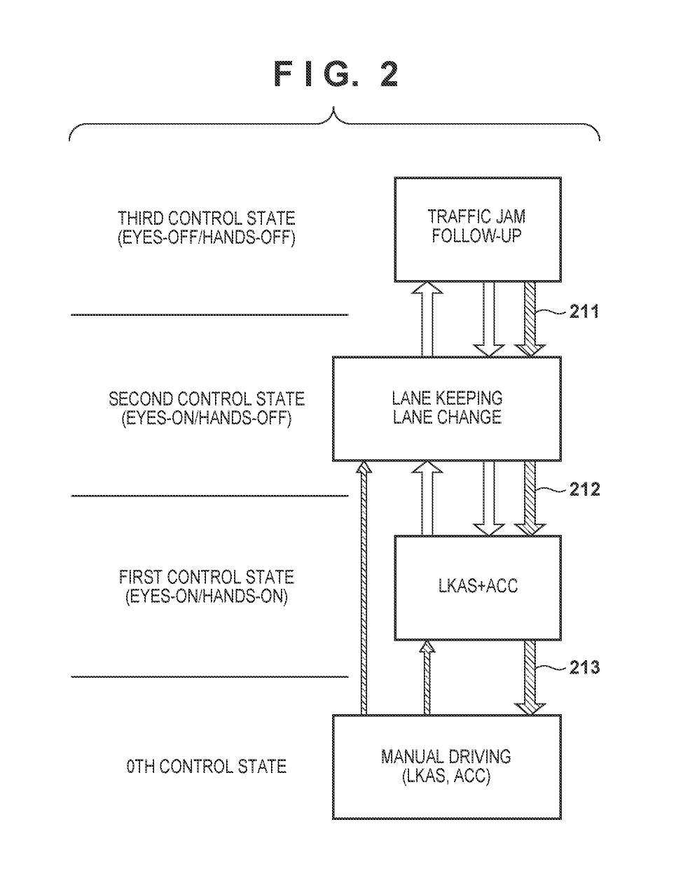

FIG. 2 illustrates a state transition diagram of the automated driving control state in the present embodiment. The present embodiment has a 0^{th} control state to a third control state as a standard (automation level) of the automated driving control state, and the levels of the automated driving control state become higher in this order. Note that in FIG. 2, arrows show transition of the state. Of the arrows, white arrows show transition of the automated driving control state which is performed by the automated driving realized by the control unit 2 (in particular, the ECU 20) executing a program, for example, that is, performed mainly by the vehicle 1. On the other hand, black arrows show transition of the automated driving control state that is performed with the operation of the driver as a trigger. Further, of the black arrows, thick black arrows 211 and 212 each shows long press of the cancel button, and a thin arrow 213 shows short press of the cancel button. The other black arrows show instructions to start automated driving in the present embodiment. Here, the respective driving control states will be described again. A difference between the long press and the short press lies in that in the long press, the button has to be depressed for such a long time that a sufficient difference occurs in operation as compared with the short press. For example, the long press may be a length about twice to several times as long as the short press, for example.

The 0^{th} control state is the control state of the manual driving, in which the driving support functions such as LKAS (lane keeping function) and ACC (adaptive cruising control function) can be used, but the automated driving control state does not change unless the driver instructs to switch to the automated driving explicitly. When the driver explicitly instructs automated driving by the switch operation, for example, in the 0^{th} control state, the automated driving control state transitions to the first control state or the second control state in response to the external environment, the vehicle information and the like at that time. The control unit 2 determines to which control state to transition by referring to the external environment information, the traveling state information and the like.

The first control state is the lowest automated driving control state of the automated driving. For example, when the present location cannot be recognized when the automated driving is instructed, or in the environment (for example, an ordinary road or the like) where the second control state cannot be applied even though the present location can be recognized, the automated driving is started in the first control state. The automation function realized in the first control state includes LKAS, ACC and the like. Further, when the automated driving control state is to transition to the first control state, the automated driving control state transitions to the first control state when the driver state detecting unit detects that the driver monitors the outside, and grasps the steering wheel, and the conditions are satisfied. Further, monitoring by the driver may be also performed continuously while the automated driving control state remains in the first control state. When the automated driving control state is caused to transition to a high level (high automation rate) from a low level (low automation rate), the state of the driver does not have to be set as the condition of transition, because the task imposed on the driver does not change or decreases.

The second control state is the automated driving control state just above the first control state. For example, when keeping the automated driving is accepted in the 0^{th} control state, and the external environment at that time is a predetermined environment (during traveling on a highway or the like, for example), the automated driving control state transitions to the second control state. Alternatively, when it is detected that the external environment is the aforementioned predetermined environment during the automated driving in the first control state, the automated driving control state automatically transitions to the second control state. Determination of the external environment may be performed by referring to the present position and the map information, besides a monitoring result of the surroundings monitoring unit including cameras and the like, for example. In the second control state, the functions of performing lane change and the like in response to the target such as vehicles in the surroundings are also provided in addition to lane keeping. When the condition of keeping the second control state is lost, the automated driving control state of the vehicle 1 is changed to the first control state by the control unit 2. In the second control state, the driver does not have to hold the steering wheel (this is referred to as hands-off), only monitoring the surroundings is imposed on the driver. Therefore, in the second control state, the driver state detecting camera 41a monitors whether the driver monitors the outside, and if the driver fails to monitor the outside, a warning, for example, is issued.

The third control state is the automated driving control state of the level just above the second control state. The automated driving control state can transition to the third control state from the second control state, but does not transition from the 0^{th} control state or the first control state by skipping the second control state. Further, transition to the third control state is not performed with the instruction of the driver as the trigger, but the transition is performed when it is determined that the fixed condition is satisfied by automated control by the control unit 2. For example, when the vehicle encounters a traffic jam and is brought into a state in which the vehicle tracks the preceding vehicle at low speed, during the automated driving in the second control state, the automated driving control state is switched to the third control state from the second control state. Determination in this case is performed based on the output by the surroundings monitoring unit such as cameras, the vehicle speed and the like. When the condition of the second control state is satisfied, for example, when the vehicle is traveling on a highway, transition of the automated driving control state is performed between the second control state and the third control state. In the third control state, the driver does not have to grasp the steering wheel or does not have to monitor surroundings, so that the state of the driver does not have to be monitored while the automated driving control state is remaining in the third control state.

Manual Cancellation of Automated Driving Control State

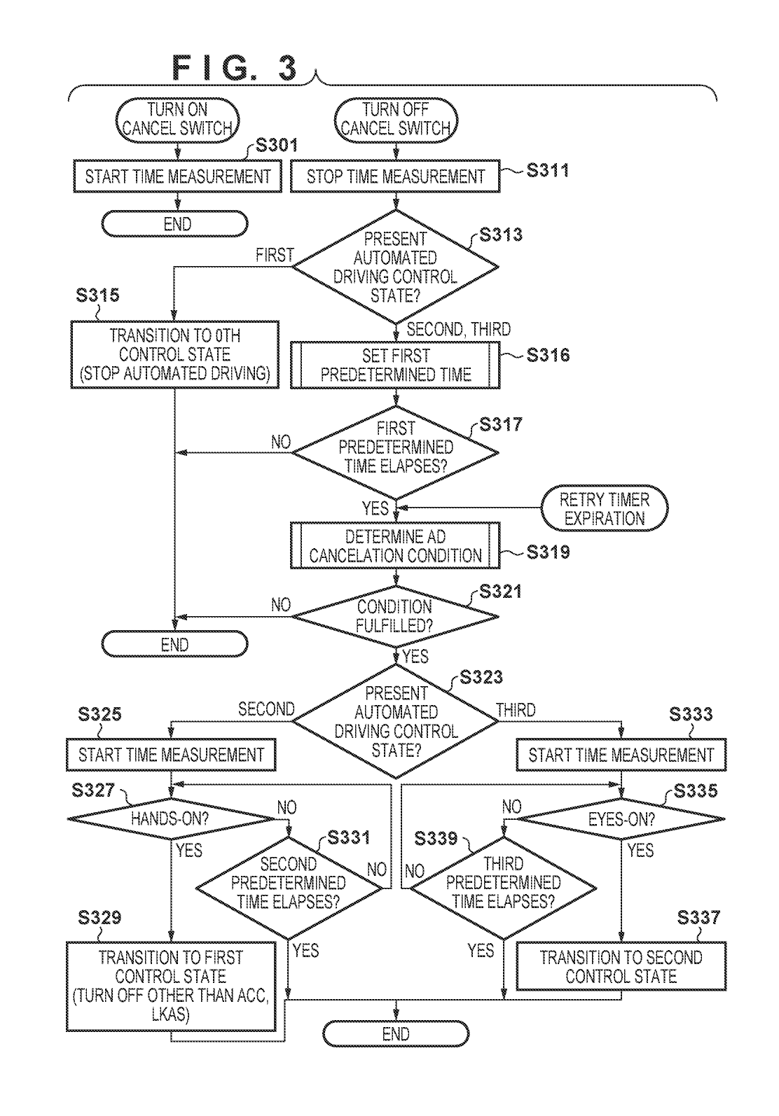

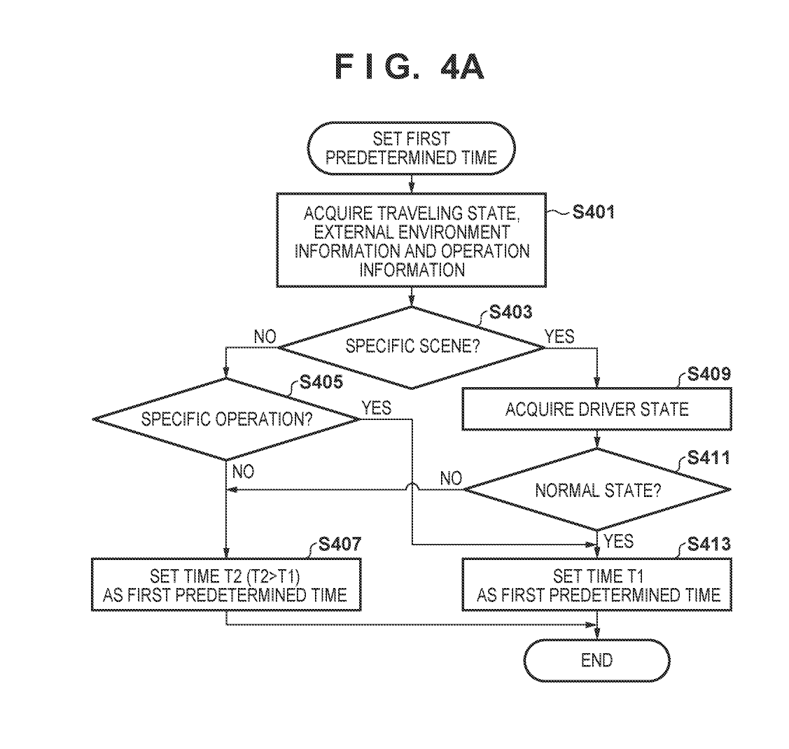

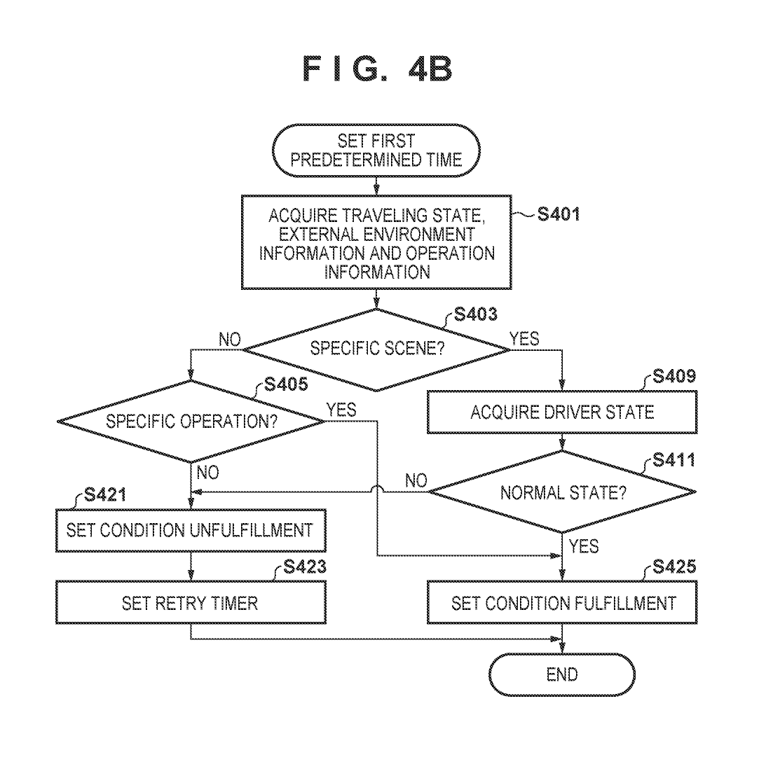

In the vehicle 1 of the present embodiment, automated driving is finished manually by operation of the cancel button, as the black arrows 211, 212 and 213 in FIG. 2, and the respective control states can be caused to transition to the control states just below the respective control states. As described above, by doing long press of the cancel button in the third control state and the second control state, and by doing short press of the cancel button in the first control state, the control unit 2 lowers the standards (automation levels) of the automated driving control state with the long press and the short press as triggers. With reference to FIGS. 3, 4A and 4B, a procedure at the time of lowering the level of the automated driving control state by the manual operation will be described.

FIG. 3 illustrates an operation procedure of the control unit 2, in particular, the ECU 20 at a time of the cancel switch being operated. An operation of the cancel button is transmitted to the ECU 20 via the ECU 28, and the ECU 20 executes the procedure in FIG. 3. First, when the cancel switch is depressed and turned on, time measurement is started by using a timer or the like to measure a time period in which the cancel switch is depressed (S301). The processing at the time of the switch being depressed is completed there.

When the cancel switch is released thereafter, a switch state is off, and with this as the trigger, step S311 is executed first. At first, time measurement is stopped (S311). The time which is measured here is a depressing time of the cancel switch. Next, a present automated driving control state is determined (S313). Information indicating the present automated driving control state is held by the ECU 20, for example. When the present automated driving control state is determined as the first control state, the control state transitions to the 0^{th} control state, that is, manual driving (S315). In this case, a length of the depressing time of the cancel button does not matter. This is because in the first control state, the driver holds the steering wheel, and monitors surroundings, so that even the control state transitions to the 0^{th} control state immediately, the driver is easily adapted to switching to the manual driving from the automated driving. In the first control state, it is checked that the driver continuously grasps the steering wheel and monitors an outside, but it may be checked again prior to transition to the 0^{th} control state.

Meanwhile, when the present automated driving control state is in the second or third control state, a first predetermined time to be a determination reference of long press is set (S316). FIG. 4A illustrates details thereof. First, a traveling state of the vehicle 1, external environment information and operation information indicating an operating state of the operation device are acquired (S401). Note that these kinds of information are referred to for determination in step S403 and step S405, so that even if the information does not include all kinds of information cited here, the information may be adopted if the information includes information necessary for determination. Conversely, information other than the information cited here may be acquired if the information is necessary in determination. Next, it is determined whether the present state corresponds to a specific scene (or a specific state) (S403). When the present state corresponds to the specific scene in step S403, a driver state is acquired from the driver state detecting camera 41a, the steering wheel grasping sensor and the like (S409). It is determined whether the driver is in a normal state (S411), and when it is determined as normal, a time T1 which is set in advance is set as a first predetermined time (S413). The time T1 may be about two or three seconds, for example. When it is determined that the driver is not in the normal state in step S411, a time T2 which is set in advance is set as the first predetermined time (S407). Here, T2>T1 is established, and the time T2 is desirably such a length that practically prohibits the cancel operation. For example, when the time T2 is about several seconds, the cancel operation is also executed, so that the time T2 may be set at several minutes or a maximum value which is settable. When it is determined that the present state does not correspond to the specific scene in step S403, it is determined whether a specific operation is performed at present (S405). When it is determined that no specific operation is performed in step S405, that is, in the case of no specific scene or no specific operation, the time T2 which is set in advance is set as the first predetermined time (S407). On the other hand, when the specific operation is performed, the time T1 which is set in advance is set as the first predetermined time (S413).

Here, the specific scene (or the specific state) refers to a state where the vehicle 1 does not make transitional movement, for example. The transitional movement includes, for example, movement to shift from one steady traveling state to another steady traveling state. The steady traveling state refers to a state in which the vehicle 1 travels at a constant steering angle (including traveling straight forward) and at a constant speed, for example. As a matter of course, “constant” is not in a strict sense, but “constant” means that it falls within a certain range of fluctuation. As the fluctuation range, an appropriate value may be determined by performing steady travel experimentally. On the other hand, when the vehicle speed and the steering angle change at a rate (that is, a change amount per unit time) exceeding a degree that can be said as constant, it can be determined as transitional movement. Accordingly, the specific scene includes a steady traveling state. Besides, a travelling state where the steering angle is smaller than a predetermined threshold, a traveling state where the acceleration is smaller than a threshold may be included in the specific scenes instead of the state where the vehicle is stopping or the steady traveling state. More widely, a state where the vehicle is not traveling in an intersection with reference to a surrounding state may be determined as the specific scene. In any case, information necessary for determination is properly collected.

Further, the specific operation includes operations to other devices which the driver can operate. For example, the specific operations may include an accelerator operation, a shift operation of the transmission, a steering wheel operation and the like. These operations can be detected by sensors provided at the respective devices. Further, the normal state of the driver may be a state where the driver is seated on the seat, and monitors the outside or the like. This can be a state required by the automated driving control state of a destination of transition, and the driver can be in a state where the driver can accept increase in the load which is imposed on the driver due to lowering of the level of the automated driving control state. The state of the driver is not confirmed when the specific operation is performed because it can be determined that the driver mainly performs the operation, but the driver state may be also confirmed by branching the process to step S409 in the case of the specific operation.

By doing as above, the first predetermined time can be set by considering the traveling state of the vehicle, the operation by the driver, the state of the driver and the like.

After the first predetermined time is set, it is determined whether the measured time exceeds the first predetermined time (S317). When the measured time does not exceed the first predetermined time, the processing is finished. Next, the process proceeds to step S319, and in the present embodiment, in step S319, condition fulfillment is always set as an AD cancellation condition. Note that a label called “retry timer expiration” is for a first modified example that will be described later. In step S321, it is determined whether or not the condition is fulfilled. When the condition is not fulfilled, the processing is finished, but in the present embodiment, the condition is always determined as fulfilled. Accordingly, in the present embodiment, the process may proceed to step S323 by skipping step S319 and step S321.

Next, the present automated driving control state is determined (S323). It is determined that automated driving in the present automated driving control state is finished and the automated driving control state shifts to the automated driving control state at a lower level at the time point when the elapsed time is determined to pass the first predetermined time in step S317, and here, the processing is distributed to processing according to each of the control states. In the case of the second control state, time measurement for a grace time period at the transition time to the automated driving control state at a lower level from the second control state is started (S325). Until the grace time period elapses, it is determined whether the driver performs hands-on (steering wheel grasping) by the steering wheel grasping sensor (S327). Since eyes-on is the condition in the second control state, determination of eyes-on is omitted here, but eyes-on may be confirmed as a matter of course. When it is determined that the driver performs hands-on, the control state transitions to the first control state (S329). In the present example, LKAS and ACC are supported in the first control state, so that the other automated driving functions than LKAS and ACC may be turned off. This can be performed in accordance with the functions of the first control state as a matter of course, and therefore, the present invention is not limited to this. For example, the same functions as in the first control state may be supported. When the driver does not perform hands-on, it is determined whether the elapsed time passes the second predetermined time (S331). When the driver does not perform hands-on within the predetermined time, the processing is finished, and the cancel operation is invalidated. Note that the second predetermined time can be approximately four seconds, for example.

In the case of the third control state, time measurement for a grace time period at the time of transition to the automated driving control state of a lower level from the third control state is started (S333). Next, until the grace time period elapses, it is determined whether the driver performs eyes-on (monitor of the external environment) by the steering wheel grasping sensor (S335). When it is determined that the driver performs eyes-on, the control state transitions to the second control state (S337). In this example, the lane change function is supported in the second control state, so that the lane change function is turned on, for example. This can be performed in accordance with the functions of the second control state as a matter of course, and therefore, the function is not limited to the lane change function. When the driver does not perform eyes-on on the other hand, it is determined whether the elapsed time passes a third predetermined time (S339). When the driver does not perform eyes-on within the predetermined time, the processing is finished, and the cancel operation is invalidated. Note that the third predetermined time can be approximately 15 seconds, for example.

As above, in the present embodiment, the operating amount (continuous operation time in the present example) is changed in the cancel operation in the first control state, and the cancel operation in the second or third control state higher than the first control state. More specifically, the time of the cancel operation in the second or third control state is set to be longer than the time of the cancel operation in the first control state. Thereby, an erroneous operation is prevented, with respect to the cancel operation in the automated driving control state in which the automation rate is higher and the load on the driver is lighter. In the automated driving control state in which the automation rate is higher, the influence on the driver due to cancellation of the automated driving control state is larger, so that in the automated driving control state with the high automation rate, a situation where the level of the automated driving control state lowers without consciousness of the driver is prevented. On the other hand, in the automated driving control state with the low automation rate, the influence on the driver by cancellation of the automated driving control state is small, so that a quick response to the operation can be made by shortening the operation time.

Further, in the present embodiment, the operation time for cancel operation is changed according to whether or not the traveling state of the vehicle is the specific scene, or whether the operation state is the specific operation, and whether the driver state is normal. That is, when the traveling state and the driver state are satisfied, or when the operation state and the driver state are satisfied, the operation time is set to be short as the state where cancellation is easily accepted, and operability can be enhanced. On the other hand, when the aforementioned conditions are not satisfied, cancellation can in practice be prohibited by increasing the operation time, for example, by increasing the operation time to be so long that cancellation cannot be accepted by an ordinary operation. By determining the traveling state where the driver easily accepts the load of a new level with allowance, as the specific scene, lowering of the automation rate of the automated driving control state or cancellation of the automated driving control state can be realized without risking unnecessary danger.

Further, the time T1 which is set in step S413 in FIG. 4A may be set to be equal to the operating amount (operation time) of the automated driving cancel operation in the first control state. In that case, the time T2 which is set in S407 may be set to be equal to the operating amount (operation time) of the automated driving cancel operation in the second and third control states. In this way, processing operability can be enhanced, although the cancel operation cannot be prohibited.

As for transition to the 0^{th} control state from the first control state, transition is performed irrespective of the operating amount, that is, the operation time, when the cancel button is operated (S313→S315). However, in the first control state, it is determined whether a depressing time of the cancel button which is measured is the second predetermined time that satisfies the condition of short press, and when the condition is satisfied, step S315 may be executed. Further, in that case, the second predetermined time which is the condition of the short press in the first control state may be set in the same way as the procedure illustrated in FIG. 4A. In this case, “the first predetermined time” illustrated in FIG. 4A can be replaced with “the second predetermined time”, the time T1 can be replaced with “the time T3 shorter than the time T1”, and “the time T2 (T2>T1)” can be replaced with “time T4 (T4>T3)”. This similarly applies to a second modified example of the first embodiment and a second embodiment that will be described later. In this way, enhancement of operability and safe lowering of the automation level can be made compatible as described above, with respect to the cancel operation in the first control state.

### First Modified Example of First Embodiment

Next, a first modified example of the first embodiment will be described. The present modified example is substantially similar to the first embodiment, but differs in two points that in step S316 in the procedure in FIG. 3, T1 is set as the first predetermined time without performing the processing in FIG. 4A, and in step S319, processing in FIG. 4B is executed. Therefore, FIG. 4B is described here, and explanation of the things other than 4B are omitted.

In FIG. 4B, a cancellation condition of automated driving is set. Here, cancellation of the automated driving means transition from the present automated driving control state to the automated driving control state at a level just below the present automated driving control state. Note that in FIG. 4B, step S407 is replaced with S421 and S423, and S413 is replaced with S425, so that only changed points will be described. In step S421, the cancellation condition of the automated driving control state being unfulfilled is set. Thereafter, a retry timer is set (S423), and the processing is finished. In order to prevent retry from being repeated more than necessary, setting of the retry timer may be limited to predetermined times, for example, one time. Further, when it is determined that it is the specific scene and the driver state is normal, or it is determined that the specific operation is performed, the cancellation condition of the automation level being fulfilled is set.

By setting in this way, in step S321 in FIG. 3, the cancel operation of the present automated driving control state is invalidated unless the predetermined condition is satisfied. On the other hand, when the condition is satisfied, the processing corresponding to the automated driving control state of the present level is continued. Here, when the retry timer is set in step S423, re-execution is performed from step S319 at the time of expiration of the retry timer. Thereby, the condition of cancellation is determined again, and when the condition is fulfilled, the present automated driving control state is cancelled, and when the condition is unfulfilled, the cancellation is invalidated.

As above, according to the present modified example, cancellation of the automated driving control state is accepted when the traveling state and the driver state are satisfied, or when the operation state and the driver state are satisfied, and otherwise, the cancel operation is invalidated. Thereby, a similar effect as in the first embodiment can be obtained. Further, according to the present modified example, retry of the cancel operation is easy.

### Second Modified Example of First Embodiment

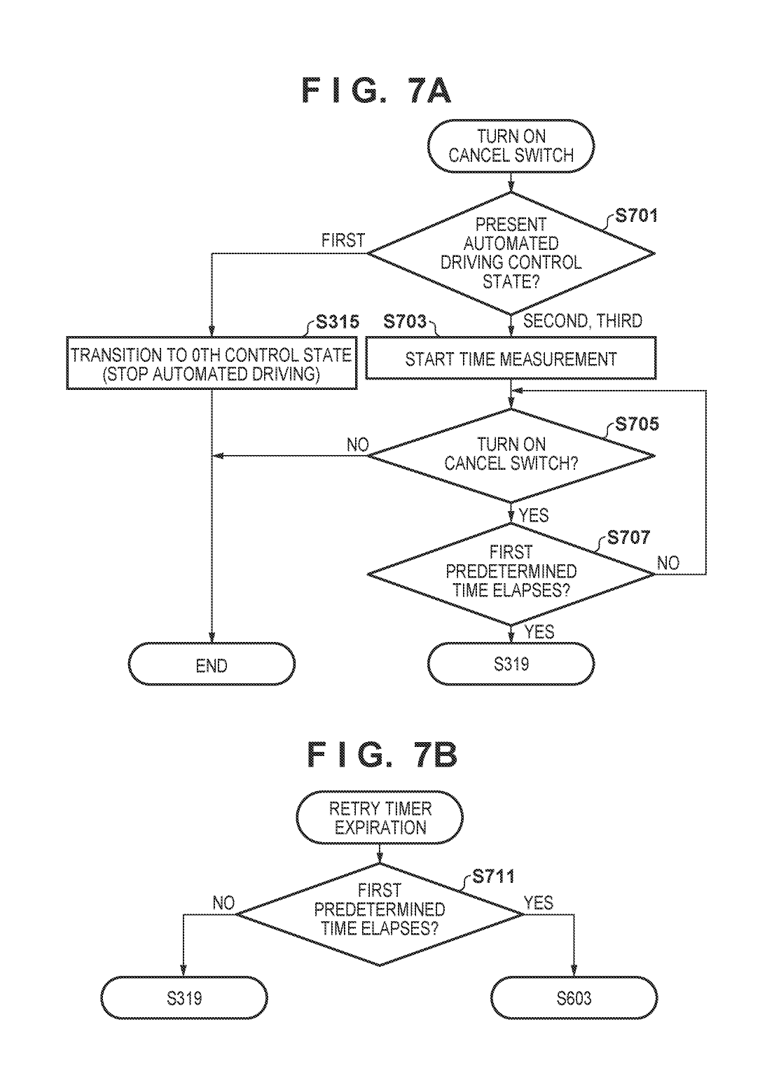

FIG. 7A illustrates a second modified example of the first embodiment. The modified example is based on the first modified example of the first embodiment. That is, the first predetermined time is fixedly given, and when the operation for a fixed time is performed, it is determined whether the present state corresponds to the cancellation condition. In the first modified example of the first embodiment, the operating amount (operation time) is determined after the cancel operation is completed, and is compared with the first predetermined time in the second and third control states. In the present modified example, it is determined that the cancel operation is performed when the first predetermined time elapses in the second and third control states even during operation, without waiting for completion of the cancel operation.

First, the present automated driving control state is determined (S701). In the first control state, the driving control state is caused to transition to the 0^{th} control state immediately (S315). In the second or third control state, time measurement is started (S703), and it is determined whether the cancel switch is continuously on (that is, kept depressed) (S705). When the cancel switch is depressed, it is determined whether the first predetermined time (for example, T1 of the first embodiment) elapses (S707), and when the first predetermined time elapses, the process branches to step S319 in FIG. 3. The present modified example is based on the first modified example, so that FIG. 4B is executed in step S319.

As above, for example, when the cancel button is kept depressed, the cancel operation of the present automated driving control state is accepted by a lapse of the predetermined time even when long press is required. Thereby, the driver does not have to be conscious of how much cancel operation the driver should perform, and operability can be enhanced more.

### Second Embodiment

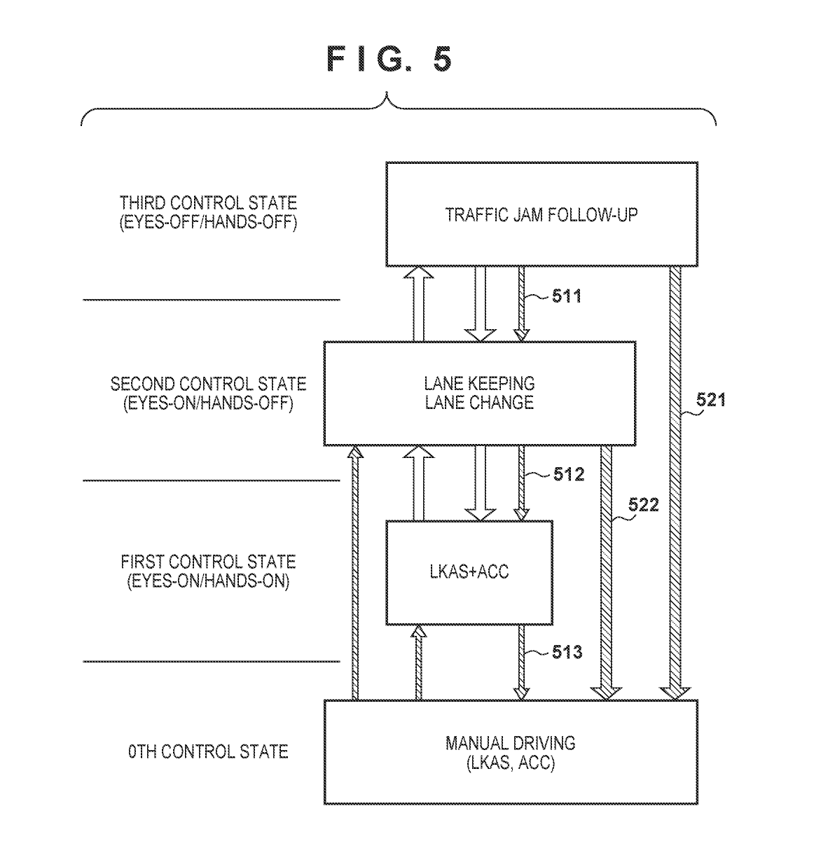

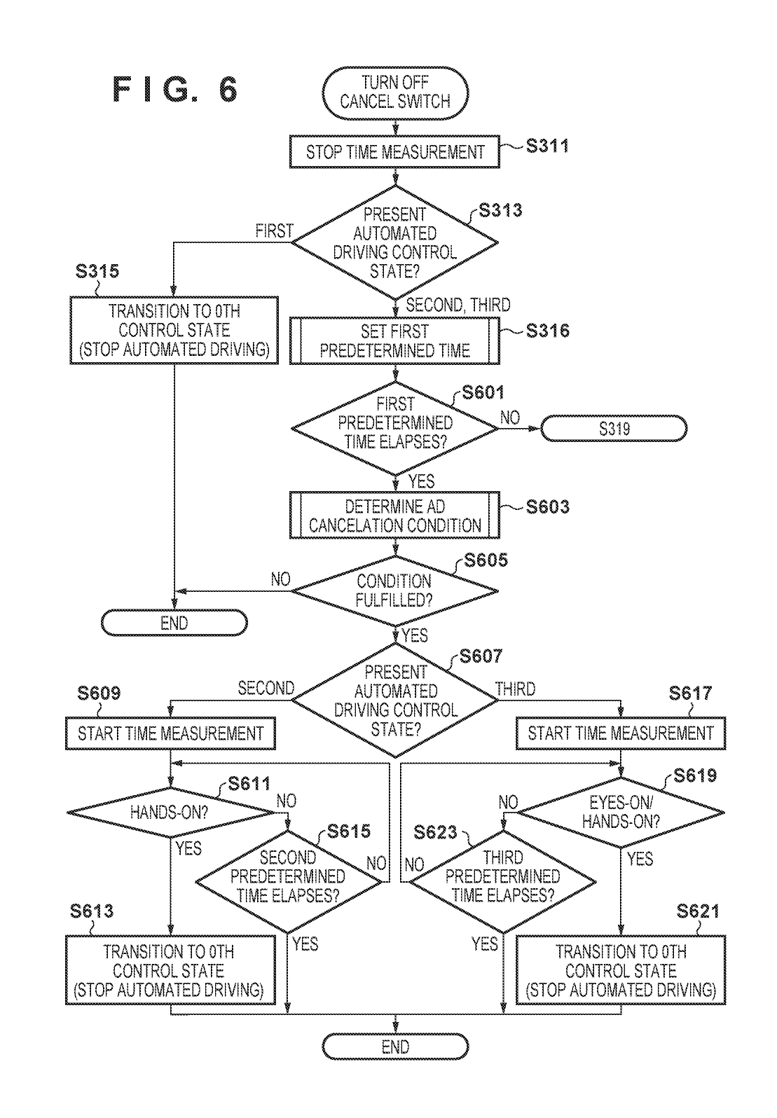

FIG. 5 illustrates a transition diagram of an automated driving control state of the second embodiment. A difference from the first embodiment is that transitions 511, 512 and 513 from certain automated driving control states to automated driving control states of levels just below the certain automated driving control states require only a cancel button operation for a short time, but transitions 521 and 522 from the third control state and the second control state to the 0^{th} control state require long press of the button. FIG. 6 illustrates an operation procedure of the control unit 2, in particular, the ECU 20 at a time of the cancel switch being operated. The procedure at a time of pressing and turning on the cancel button is similar to step S301 in FIG. 3. When the cancel switch is released thereafter, the switch state is turned off, and the procedure in FIG. 6 is executed.

First, time measurement is stopped (S311). The time which is measured here is a depressing time of the cancel switch. Next, a present automated driving control state is determined (S313), Information indicating the present automated driving control state is held by the ECU 20, for example. When the present automated driving control state is determined as the first control state, the control state transitions to the 0^{th} control state, that is, manual driving (S315). In this case, the length of the depressing time of the cancel button does not matter. This is because in the first control state, the driver holds the steering wheel, and monitors surroundings, and the driver is easily adapted to switching to the manual driving from the automated driving even when the control state immediately transitions to the 0^{th} control state. In the first control state, it is checked that the driver continuously grasps the steering wheel, and monitors the outside, but it may be checked again prior to transition to the 0^{th} control state.

When the present automated driving control state is the second or third control state, the first predetermined time to be the determination reference of long press is set (S316). This is executed in the procedure in FIG. 4A as described in the first embodiment, so that explanation will be omitted. In step S316, the first predetermined time can be set by considering the traveling state of the vehicle, the operation by the driver, the state of the driver and the like.

After the first predetermined time is set, it is determined whether the measured time exceeds the first predetermined time (S601). When the measured time does not exceed the first predetermined time, the process branches to step S319. That is, the same processing as in the case of long press being performed in the first embodiment is executed. This is to realize the transitions 511 and 512 in FIG. 5 by short press. Next, the process proceeds to step S603, and in the present embodiment, condition fulfillment is always set as the AD cancellation condition in step S603. Determination of the AD cancellation condition may be performed before branch in step S601. Subsequently, in step S603, whether the condition is fulfilled or not is determined. When the condition is not fulfilled, the processing is finished, but in the present embodiment, it is always determined that the condition is fulfilled. Accordingly, in the present embodiment, the process may proceed to step S607 by skipping step S603 and step S605.

Next, the present automated driving control state is determined (S607). At the time point when it is determined that the elapsed time passes the first predetermine time in step S601, the automated driving control state at the present level is determined to be finished and shift to the 0^{th} control state, and here, the processing is distributed to the processing which corresponds to each of the control states. In the case of the second control state, time measurement for a grace time period at the time of transition of the control state to the 0^{th} control state from the second control state is started (S609). Until the grace time period elapses, it is determined whether the driver performs hands-on (steering wheel grasping) by the steering wheel grasping sensor (S611). In the second control state, eyes-on is the condition, and therefore determination of eyes-on is omitted here, but eyes-on may be confirmed as a matter of course. After it is determined that the driver performs hands-on, the control state transitions to the 0^{th} control state (S613). In the present example, the 0^{th} control state is manual driving, and therefore automated driving is stopped. However, even in the 0^{th} control state, LKAS and ACC are also supported, so that these functions are continued. As a matter of course, this can be performed in accordance with the functions of the 0^{th} control state, so that the functions are not limited to these functions. When the driver does not perform hands-on, it is determined whether the second predetermined time elapses (S615). When the driver does not perform hands-on within a predetermined time, the processing is finished, and the cancel operation is invalidated. Note that the second predetermined time can be approximately four seconds, for example.

In the case of the third control state, time measurement for a grace time period at the time of transition of the control state to the 0^{th} control state from the third control state is started (S617). Until the grace time period elapses, it is determined whether the driver performs eyes-on (monitoring of the external environment), and further whether the driver performs hands-on by the steering wheel grasping sensor (S619). When it is determined that the driver performs eyes-on, the control state transitions to the 0^{th} control state (S621). This may be similar to step S613. When the driver does not perform eyes-on and hands-on, it is determined that a third predetermined time elapses (S623). When the driver does not perform eyes-on and hands-on within the predetermined time, the processing is finished, and the cancel operation is invalidated. Note that the third predetermined time may be approximately 15 seconds, for example.

As above, in the present embodiment, the operating amount of the cancel operation (the operation time in the present example) is changed according to the difference to the automated driving control state to which the control state transitions. More specifically, as compared with the time of the cancel operation for transition from a certain automated driving control state to the automated driving control state at a level just below the certain automated driving control state, the time of the cancel operation for skipping the driving control state at the level just below the certain automated driving control state to transition to the automated driving control state at a level further below the level just below the certain automated driving control state is set to be longer. Thereby, an erroneous operation is prevented with respect to the cancel operation of the automated driving control state where the difference from the automated driving control states before and after transition is large, and the load on the driver is light. As the level difference before and after transition is larger, the influence on the driver by transition of the automated driving control state is larger, so that when the level is large, the situation where the level of the automated driving control state lowers without consciousness of the driver is prevented. When the difference in the level of the automated driving control states before and after transition is small, for example, in the case of 1, the influence on the driver which is given by transition of the automated driving control state by the cancel operation is small, so that response can be made to the operation quickly by shortening the operation time.

Further, in the present embodiment, the operation time for the cancel operation is changed according to whether the traveling state of the vehicle is the specific scene, or whether the operation state is the specific operation, and whether the driver state is normal. That is, when the traveling state and the driver state are satisfied, or when the operation state and the driver state are satisfied, the operation time is set to be short as the state where the cancellation is easily accepted, and operability can be enhanced. On the other hand, when the aforementioned conditions are not satisfied, the operation time is set to be long, for example, to be so long that cancellation cannot be accepted by an ordinary operation, and thereby cancellation can in practice be prohibited. As the specific scene, the traveling state where the driver easily accepts a load of a new level with an allowance is determined, and thereby cancellation of the automated driving control state can be realized without risking unnecessary danger.

Note that in the present embodiment, as for the case where the level difference of the automated driving control states before and after transition is one, when the cancel button is operated, transition is performed irrespective of the operating amount, that is, the operation time. However, in that case, it may be determined whether the depressing time of the cancel button which is measured is the second predetermined time that satisfies the condition of short press, and when the condition is satisfied, steps S315 and S319 and the following steps may be executed. Further, in that case, the second predetermined time which is the condition of short press in the first control state may be set in the same way as the procedure illustrated in FIG. 4A. This is the same as in the first embodiment.

### First Modified Example of Second Embodiment

Next, a first modified example of the second embodiment will be described. The present modified example is substantially a result of the first modified example of the first embodiment being applied to the second embodiment. That is, in step S316, a fixed value, for example, T1 of the second embodiment is set to the first predetermined time. Further, in step S603, FIG. 4B is executed, and the AD cancellation condition (that is, the cancel condition of the present automated driving control state) is determined. However, the processing at the time of retry timer expiration which is set in step S423 is performed as in FIG. 7B. That is, it is determined whether the time measured in steps S301 to S311 passes the first predetermined time, and when the measured time passes the first predetermined time, it is retry in the case of long press being performed, so that process branches to step S603, and otherwise, it is retry in the case of short press being performed, so that the process branches to step S319. In this way, the cancel operation which is not executed once as the condition is not fulfilled can be retried again.

As above, according to the present modified example, when the traveling state and the driver state are satisfied, or when the operation state and the driver state are satisfied, cancellation of the automation level is accepted, and otherwise the cancellation is invalidated. According to this, a similar effect as in the second embodiment also can be obtained. Further, according to the present modified example, retry of the cancel operation is easy.

Note that with respect to the second embodiment, the configuration corresponding to modified example 2 of the first embodiment can be also realized. However, in the present embodiment, operations of both short press and long press are allowed in the one automated driving control state. Therefore, when the cancel operation is completed before the time corresponding to long press elapses, it is determined as short press, and when the time corresponding to long press elapses, it is determined as long press at that point of time even when the operation is continued. By being configured in this way, also in the present embodiment, a configuration corresponding to the first modified example of the first embodiment can be realized. Thereby, a quicker cancel operation is enabled, and contribution can be made to enhancement in operability.

Note that in the above described embodiments and modified examples, the operation time is taken as an example of the operating amount, but for example when an operating device in which on and off are not fixed in binary is used in place of the cancel switch, a spatial moving amount (for example, a distance) with which the operating device is operated may be adopted as an operating amount. In this way, as the operating amount, either a temporal or spatial amount may be used, and the temporal and the spatial amounts may be combined. Further, in FIGS. 4A and 4B, for example, even in the specific scene, cancellation of the present automated driving control state is not performed unless the driver state is normal. However, the driver state may not be included in the condition of cancellation of the present automated driving control state, without performing steps S409 and S411. Further, in FIGS. 4A and 4B, it is determined whether the specific scene or the specific operation satisfies the condition or not, but only either one may be set as the condition. Further, in the above described embodiments and modified examples, the effect of the cancel operation of the driver is switched according to the depressing time such as long press and short press, but the effect of the cancel operation may be switched according to not only long press and short press, but also strong press and weak press by detecting a pressure sensitive degree of the button. In this case, for example, strong press may be configured to correspond to long press, and weak press may be configured to correspond to short press. The operations may be associated with long press and short press in the above described embodiments by large and small of the operation stroke, presence and absence of a modifier to the operation (for example, the cancel operation is performed after a specific operation is performed, and the like).

Summary of the Embodiment

The present embodiment described above is summarized as follows.

(1) According to a first aspect of the present invention, the present invention is characterized by

having a surroundings monitor provided in a vehicle to monitor a surrounding state of the vehicle, and

a vehicle controller that performs control of the vehicle based on the surrounding state monitored by the surroundings monitor, and characterized in that

a control state by the vehicle controller includes a first state, and a second state in which an automation control state of the control is higher than in the first state, and

operation methods of respective operations for finishing the first state and the second state by operation of a driver or determination methods of the operations are different in the first state and the second state.

According to the configuration, determination of an erroneous operation is changed in the first state and the second state, quick processing and careful determination are made compatible, and contribution is made to enhancement in operability and safety.

(2) According to a second aspect of the present invention, the vehicle control device according to (1) is characterized in that

the operation methods are made to be the same, and the operating amounts are different in the first state and the second state.

According to the configuration, by adopting the same operation method, operability can be enhanced.

(3) According to a third aspect of the present invention, the vehicle control device according to (2) is characterized in that

the operating amount concerning the second state is made larger than the operating amount concerning the first state.

According to the configuration, the operating amount of the first state is made larger than the operating amount of the second state, it can be made easy to determine an erroneous operation or it can be made difficult to determine an erroneous operation in accordance with the respective states, and contribution can be made to enhancement in operability and safety.

(4) According to a fourth aspect of the present invention, the vehicle control device according to any one of (2) to (3) is characterized by further having

traveling state monitor that monitors a traveling state of the vehicle, and characterized in that

the vehicle controller sets the operating amount concerning at least one of the first state and the second state based on at least either one of the traveling state and the surrounding state, and

in a case where at least either one of the traveling state and the surrounding state corresponds to a specific state, the operating amount is set to be smaller than in a case where at least either one of the traveling state and the surrounding state does not correspond to the specific state.

According to the configuration, it becomes possible to enhance operability of the driver by making it easy to finish a present automated driving control state in the specific state.

(5) According to a fifth aspect of the present invention, the vehicle control device according to any one of (1) to (3) is characterized by further having

vehicle state monitor that monitors a traveling state of the vehicle, and characterized in that

the vehicle controller does not finish the automated driving control state by the operation when at least either one of the traveling state and the surrounding state does not correspond to a specific state.

According to the configuration, the present automated driving control state is not finished unless the state is the specific state, and thereby safety can be further enhanced.

(6) According to a sixth aspect of the present invention, the vehicle control device according to any one of (2) to (5) is characterized by further having

driver state detector that detects a driver state, and characterized in that

the vehicle controller reduces the operating amount when the driver state detected by the driver state detector is normal.

According to the configuration, it becomes possible to perform cancellation properly when the driver is normal.

(7) According to a seventh aspect of the present invention, the vehicle control device according to any one of (2) to (6) is characterized in that

the vehicle controller sets the operating amount to be small according to a state of another operation capable of being operated by the driver, when the vehicle controller accepts the operation of finishing the state by the driver in each of the first state and second state.

According to the configuration, it becomes possible to finish the present automated driving control state quickly when accepting the operation of finishing the present automated driving control state with an override operation, by detecting the state of another operation device.

(8) According to an eighth aspect of the present invention, the vehicle control device according to any one of (1) to (7) is characterized in that

the vehicle controller finishes each of the first state and the second state in response to the operation for each of the states, and causes each of the first state and the second state to transition to a state in which a level of an automated driving control state is one step lower than each of the states.

According to the configuration, the automated driving control state is caused to transition step by step, so that the driver is easily adapted.

(9) According to a ninth aspect of the present invention, the vehicle control device according to any one of (1) to (7) is characterized in that

the vehicle controller finishes each of the first state and the second state in response to the operation for each of the states, and causes each of the states to transition to manual driving.

According to the configuration, the automation level is lowered to the manual driving, so that the intention of the driver can be quickly reflected.

What is claimed is:

1. A vehicle control device, comprising:
a surroundings monitor provided in a vehicle to monitor a surrounding state of the vehicle; and
a vehicle controller that performs control of the vehicle based on the surrounding state monitored by the surroundings monitor,
wherein a control state by the vehicle controller includes a first state and a second state in which an automation level of the control is higher than in the first state, and
operation methods of respective operations for finishing the first state and the second state by operation of a driver or determination methods of the operations are different in the first state and the second state.

2. The vehicle control device according to claim 1,
wherein the operation methods are made to be the same, and operating amounts are different in the first state and the second state.

3. The vehicle control device according to claim 2,
wherein the operating amount concerning the second state is made larger than the operating amount concerning the first state.

4. The vehicle control device according to claim 2, further comprising:
a traveling state monitor that monitors a traveling state of the vehicle,
wherein the vehicle controller sets the operating amount concerning at least one of the first state and the second state, based on at least either one of the traveling state and the surrounding state, and
in a case where at least either one of the traveling state and the surrounding state corresponds to a specific state, the operating amount is set to be smaller than in a case where at least either one of the traveling state and the surrounding state does not correspond to the specific state.

5. The vehicle control device according to claim 1, further comprising:
a vehicle state monitor that monitors a traveling state of the vehicle,
wherein the vehicle controller does not finish the automation level by the operation when at least either one of the traveling state and the surrounding state does not correspond to a specific state.

6. The vehicle control device according to claim 2, further comprising:
a driver state detector that detects a driver state,
wherein the vehicle controller reduces the operating amount when the driver state detected by the driver state detector is normal.

7. The vehicle control device according to claim 2,
wherein the vehicle controller sets the operating amount to be small according to a state of another operation capable of being operated by the driver, when the vehicle controller accepts the operation of finishing the states by the driver in each of the first state and the second state.

8. The vehicle control device according to claim 1,
wherein the vehicle controller finishes each of the first state and the second state in response to the operation concerning each of the states, and causes each of the first state and second state to transition to a state in which an automation level is one step lower than each of the states.

9. The vehicle control device according to claim 1,
wherein the vehicle controller finishes each of the first state and the second state in response to the operation concerning each of the states, and causes each of the first state and the second state to transition to manual driving.
